(19) United States
(12) Patent Application Publication
(10) Pub. No.: US 2008/0301033 A1
(43) Pub. Date: Dec. 4, 2008

(54) METHOD AND APPARATUS FOR OPTIMIZING LONG TERM REVENUES IN ONLINE AUCTIONS

(75) Inventors: Sudhir K. SINGH, Los Angeles, CA (US); Vwani P. Roychowdhury, Los Angeles, CA (US); Behnam A. Rezaei, Los Angeles, CA (US)

Correspondence Address: SUGHRUE MION, PLLC, 2100 PENNSYLVANIA AVENUE, N.W., SUITE 800, WASHINGTON, DC, 20037, US

(73) Assignee: NETSEER, INC., Los Angeles, CA (US)

(21) Appl. No.: 12/130,171

(22) Filed: May 30, 2008

Related U.S. Application Data
(60) Provisional application No. 60/941,607, filed on Jun. 1, 2007.

(51) Int. Cl. G06Q 30/00

(52) U.S. Cl. 705/37

(57) ABSTRACT

A method and apparatus for optimizing long-term revenues in online auctions of distinguishable units of an item. For example, the item might be a specific keyword in sponsored search where the distinguishable units could be different slots for putting ads. The system can estimate parameters such as relevance and value by using a notion of fairness and can optimize the revenue by effecting the users' incentives and by improving the bidding language. In general, the method and the system can also be used for equivalent offline auctions.

### CROSS-REFERENCE TO RELATED PATENT APPLICATION

This regular U.S. patent application claims the benefit of priority under 35 U.S.C. 119(e) from U.S. Provisional Patent Application No. 60/941,607 filed Jun. 1, 2007; the entire disclosure of which is incorporated herein by reference.

### FIELD OF THE INVENTION

This invention generally relates to long-term optimization in selling distinguishable units of an item, e.g. advertisements in response to a user's web search query. Such optimization could include automatic exploration for learning various parameters such as the relevance of a buyer to the item etc.

### DESCRIPTION OF THE RELATED ART

With the growing popularity of web search for obtaining information, sponsored search advertising, where advertisers pay to appear alongside the algorithmic/organic search results, has become a significant business model today and is largely responsible for the success of Internet Search giants such as Google and Yahoo!. In this form of advertising, the Search Engine allocates the advertising space using an auction. Advertisers bid upon specific keywords. When a user searches for a keyword, the search engine (the auctioneer) allocates the advertising space to the bidding merchants based on their bid values and their ads are listed accordingly. Usually, the sponsored search results appear in a separate section of the page designated as “sponsored” above or to the right of the organic/algorithmic results and have similar display format as the algorithmic results. Each position in such a list of sponsored links is called a slot. Whenever a user clicks on an ad, the corresponding advertiser pays an amount specified by the auctioneer. Generally, users are more likely to click on a higher ranked slot, therefore advertisers prefer to be in higher ranked slots and compete for them. From above description, we can note that after merchants have bid for a specific keyword, when that keyword is queried, auctioneer follows two steps. First, she allocates the slots to the advertisers depending on their bid values. Normally, this allocation is done using some ranking function. Secondly, she decides, through some pricing scheme, how much a merchant should be charged if the user clicks on her ad and in general this depends on which slot she got, on her bid and that of others. In the auction formats for sponsored search, there are two ranking functions namely rank by bid (RBB) and rank by revenue (RBR) and there are two pricing schemes namely generalized first pricing (GFP) and generalized second pricing (GSP) which have been used widely. In RBB, bidders are ranked according to their bid values. The advertiser with the highest bid gets first slot, that with the second highest bid get the second slot and so on. In RBR, the bidders are ranked according to the product of their bid value and quality score. The quality score represents the merchant's relevance to the specific keyword, which can basically be interpreted as the possibility that her ad will be viewed if given a slot irrespective of what slot position she is given. In GFP, the bidders are essentially charged the amount they bid and in GSP they are charged an amount which is enough to ensure their current slot position. For example, under RBB allocation, GSP charges a bidder an amount equal to the bid value of the bidder just below her. Formally, the classical framework of sponsored search advertising model being used today can be described as follows. There are K slots to be allocated among N (≧K) bidders. A bidder i has a true valuation tᵢ (known only to the bidder i) for the specific keyword and she bids vᵢ. The expected click through rate (CTR) of an ad put by bidder i when allocated slot j has the form γⱼ eᵢ i.e. separable in to a position effect and an advertiser effect. γⱼ's can be interpreted as the probability that an ad will be noticed when put in slot j and it is assumed that γ₁>γ₂> . . . >γ_{K}>0. eᵢ can be interpreted as the probability that an ad put by bidder i will be clicked on if noticed and is referred as the relevance of bidder i. This is the quality score used in the RBR allocation rule mentioned earlier. The payoff/utility of bidder i when given slot j at a price of p is given by γⱼ eᵢ (tᵢ−p) and they are assumed to be rational agents trying to maximize their payoffs. The above framework is in general applicable to the auctions of any item that can come in distinct units with different qualities. A slot can be interpreted in general as a unit of the item wherein the qualities of the units are interpreted as click through rates. Note that the users/consumers are implicitly included in the framework as ones who perform the clicks or in the general case the ones who define the quality of the different units of the items by their preferences for those units. In the following, the term slot is used in this more general context and other parameters as noted in the following Table.

| Symbol | Stands for (in case of keyword auctions/in general) |
|---|---|
| N | total number of advertisers/total number of bidders |
| K | total number of slots for the specific keyword/ |
| | total number of distinct units of the item |
| tᵢ | true valuation of advertiser i for the specific keyword/ |
| | true valuation of bidder i for the item |
| vᵢ | the amount bid by advertiser i/the amount bid by bidder i |
| CTRᵢⱼ | Click-Through-Rate of advertiser i when placed at the slot j/ |
| | quality of the j^{th} unit of the item when given to bidder i |
| γⱼ | Click-Through-Rate of slot j (the position based effect)/ |
| | quality of j^{th} unit of the item |
| eᵢ | relevance of advertiser i/ |
| | relevance (fitness) of bidder i for the item |

In the classical framework described above it is implicitly assumed that the auctioneer knows parameters such as the relevance eᵢ's but in practice this is not entirely true as new bidders do also join the game. Further, it is also assumed that the bidders know their true valuations well and bid accordingly, and high budget bidders and low budget bidders have similar awareness and risk levels. In reality, a low budget bidder might not know his true value and what to bid and might also not be able to bid a very high value due to possible risk involved. Certainly, a model is desirable which automatically allows to estimate these parameters—the auctioneer can estimate the relevance as well as the bidders will be able to figure out their valuations and can bid more efficiently. Furthermore, in thinking about whether one switch from one mechanism to another it is not enough to look at the mechanism in isolation but one need also have to think about how that is going to effect the pool of bidders that we are going to attract. Further, the prior methods do not stress and optimize from the fact that the click through rates (position based or overall) change with the type of models/mechanisms used. Thus it might be possible that some mechanism is more profitable in terms of revenue in short run than another while the other might have an effect of increasing CTRs for example by effecting the incentives of users and therefore the later mechanism might turn out to be more profitable in the long run. Furthermore, the currently used methods do not account for and do not optimize from the possibility that the quality of a particular unit of the item given to a particular bidder might also be effected by the identity of the bidders who got the other units and also the bidders might in general have different motivations behind buying the item and accordingly they might have some payment level preferences. For example, in the case of adword auctions, CTR of an ad can depend on what are the other ads put in the nearby slots and the advertisers in general have different motivations behind advertising and accordingly they might be interested in paying in terms of PPM, PPC or PPA as suited to their needs. Certainly, methods for accounting for these parameters are also desirable.

Therefore, what is needed are methods that can estimate parameters such as relevance and value, and can optimize the revenue by effecting the users' incentives and by improving the bidding language.

### SUMMARY OF THE INVENTION

The inventive methodology is directed to methods and systems that substantially obviate one or more of the above and other problems associated with conventional techniques for auctioning distinguishable units of an item.

A system for optimizing long-term revenues in online auctions of distinguishable units of an item by incorporating parameters such as fairness, users' incentives and bidders' expressiveness. For example, the item might be a specific keyword in sponsored search where the distinguishable units could be different slots for putting ads. In general, the system can also be used for equivalent offline auctions. The system has various modules to implement methods provided by various embodiments of the present invention as described in the following. In one embodiment, the present invention introduces a notion of fairness in the models for online auctions which provides a chance to new bidders as well as lower budget bidders to obtain better (top) slots. This can enable the auctioneer (the search engine in the case of keyword auctions in sponsored search) to estimate the quality scores for new bidders (advertisers) and to cater the bidders (advertisers) in the tail better thereby encouraging more bidders (advertisers) to participate. This embodiment is described and illustrated in the Section 1.1. In another embodiment as summarized in Section 1.2, the present invention incorporates parameters that effects users' incentives and provides methods that can potentially improve CTRs by bringing the users in the bargaining process, directly or indirectly. In yet another embodiment as summarized in Section 1.3, the present invention provides methods that improve the bidding language and account for bidders' expressiveness at allocation as well as payment level.

Specifically, in accordance with one aspect of a the inventive concept, there is provided a method for auctioning an item having multiple distinct units to a plurality of bidders, where each of the multiple distinct units has at least one different quality. The inventive method involves designating at least one of the multiple distinct units as fair slots and determining multiple bidders who qualify for the fair slots using a qualifying rule.

In accordance with another aspect of the inventive concept, there is provided a method for optimizing long term revenue in a system for auctioning of a multiple slots to a multiple bidders by effecting user incentives. The inventive method involves: receiving multiple bids for the multiple slots from the multiple bidders; ranking the multiple bidders by relevance and choosing multiple top bidders and assigning at least some of the multiple slots to the multiple top bidders using an allocation rule. The inventive method further involves charging the multiple top bidders who have been assigned at least some of the multiple slots using a pricing scheme and providing the assigned slots to the multiple top bidders.

In accordance with yet another aspect of the inventive concept, there is provided a method for optimizing long term revenue in a system for auctioning of multiple slots to multiple bidders by improving a bidding language. The inventive method involves: designating at least one slot of the multiple slots as express slots, wherein bidders are allowed to express allocation level preferences with respect to the express slots, the allocation level preferences including a list of excluded bidders for each bidder that the bidder does not desire to appear in the express slots.

In accordance with a further aspect of the inventive concept, there is provided a method for enabling payment level preferences of bidders in an auction of multiple slots to multiple bidders. The inventive method involves: receiving from each bidder bid information, the bid information including an amount the bidder wants to pay per an impression, the extra amount the bidder wants to pay if the bidder gets a click and an extra amount the bidder is willing to pay if the bidder gets a conversion; using a qualifying rule to identify bidders who will actually participate; using an allocation rule to assign the multiple slots to the participating bidders; and using a pricing scheme to determine payments from the participating bidders.

In accordance with yet further aspect of the inventive concept, there is provided a method for estimating a relevance score of a new bidder in auctioning of a multiple advertisement slots to multiple bidders. The inventive method involves: receiving multiple bids for the multiple advertisement slots from the multiple bidders and ranking the bidders using a product of respective bids and respective relevances (RBR). In the inventive method, the new bidder is assigned an initial relevance such that the new bidder obtains an advertisement slot without causing any loss in an expected revenue of an auctioneer with respect to that coming from other bidders in absence of the new bidder. The inventive method further involves estimating a true relevance of the new bidder proportionally to a number of activations of an advertisement of the bidder.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary layouts of a page returned after a search query by the schemes currently used; A and S stand for “algorithmic results” and “sponsored results” respectively and O is for “other” items such as “narrow/expand your search”, “local results” etc.

FIG. 2 illustrates an exemplary structure of the current schemes for sponsored search advertisements; S is the set of advertisers/bidders interested in the specific keyword; S does also represents the set of values/information that those bidders provide to the system; A is the allocation rule used by the scheme to assign the slots to the bidders; P is the pricing rule to determine the payments of the bidders who were assigned the slots.

FIG. 3 illustrates an exemplary layout of a page returned after a search query by the CFFM schemes proposed in the present invention; A stands for “algorithmic results”, F is for “fair slots”, U is for “non-fair slots” (usual slots) and E stands for “exclusive slots”.

FIG. 4 illustrates an exemplary layout of a page returned after a search query by the schemes for incorporating allocation level expressiveness of bidders as proposed in the present invention (Section 1.3.1); A stands for “algorithmic results”, E is for “express slots” and U is for “non-express slots” (usual slots).

FIG. 5 illustrates an exemplary embodiment of an inventive system; 7, 11 etc are modules implementing methods provided by various preferred embodiments of the present invention, 2 represents the information being submitted by the bidders to the system through the interface 3; 7 is the module to implement the method for fairness and 11 is the module to estimate various parameters such as relevance using the CFFM; 13, 17 implements the methods effecting user incentives by ranking by relevance and by user payback respectively; 19,23 are modules for allocation level and payment level bidders' expressiveness respectively and 29 is the other method described in Section 1.4 to estimate relevance.

FIG. 6 illustrates an exemplary structure of CFFM schemes of the present invention; the algorithm starts with I=0.

FIG. 7 illustrates an exemplary structure of “relevance based scheme” proposed in the present invention and described in Section 1.2.

FIG. 8 illustrates an exemplary structure of schemes to incorporate “express slots” i.e. allocation level preferences of the bidders of the present invention as described below.

FIG. 9 illustrates an exemplary embodiment of a computer platform upon which the present invention may be implemented.

### DETAILED DESCRIPTION

In the following detailed description, reference will be made to the accompanying drawings, in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

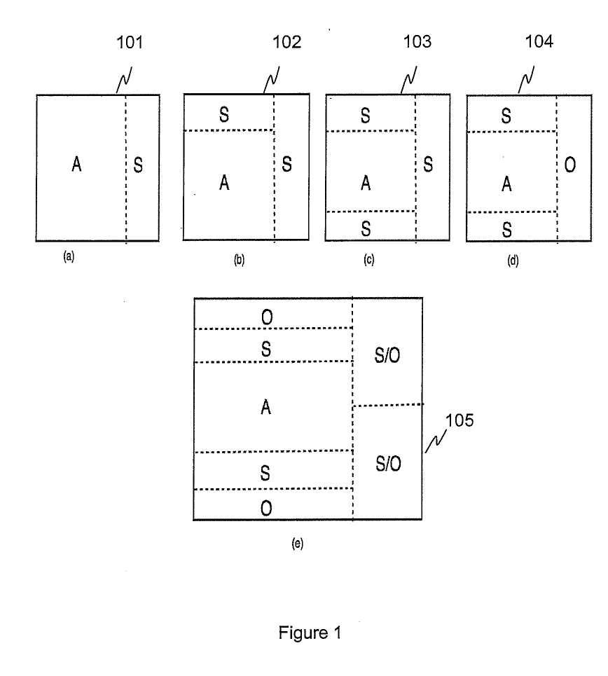

FIG. 1 illustrates an exemplary layouts 101-105 of a page returned after a search query by the schemes currently used; A and S stand for “algorithmic results” and “sponsored results” respectively and O is for “other” items such as “narrow/expand your search”, “local results” etc.

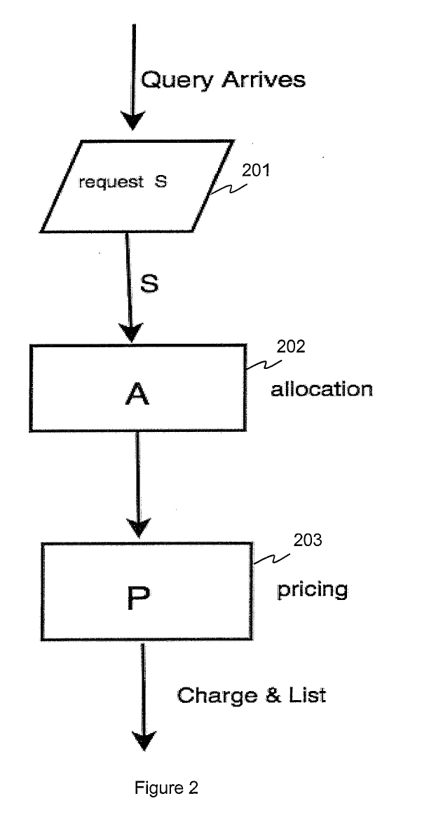

FIG. 2 illustrates an exemplary structure of the current schemes for sponsored search advertisements; S 201 is the set of advertisers/bidders interested in the specific keyword; S 201 does also represents the set of values/information that those bidders provide to the system; A 202 is the allocation rule used by the scheme to assign the slots to the bidders; P 203 is the pricing rule to determine the payments of the bidders who were assigned the slots.

1.1 Fairness without Loss

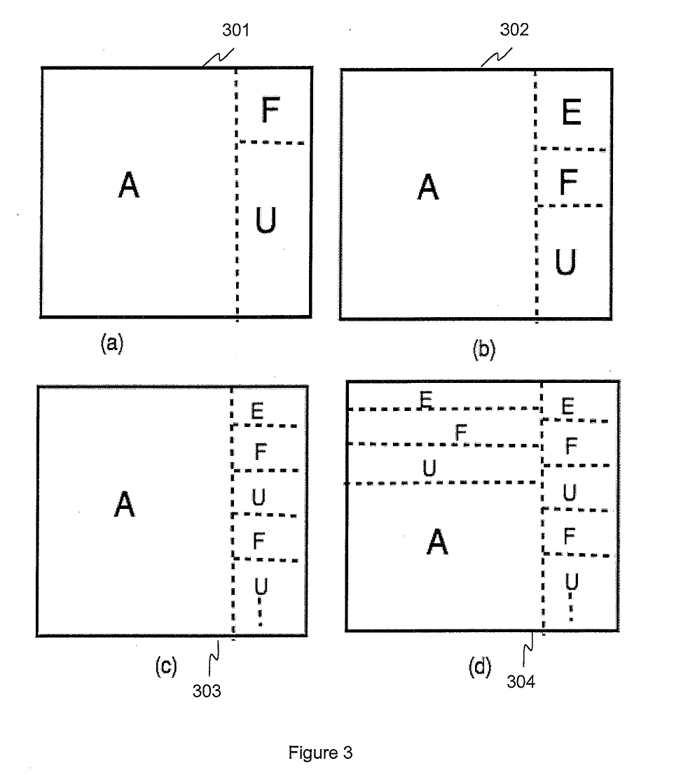

The first embodiment of the present invention which introduces a notion of fairness in online auctions framework will now be described. In this new framework, there are specified slots which are designated as fair. The auctioneer/system decides upon which bidders qualify for the fair slots and the bidders who qualify are given equal chance to appear in the fair slots. Therefore, with fairness, the lowly ranked bidders are also given chance to obtain top/better slots. This can potentially result in attracting the pools of bidders from the tail. High budget bidders may also not be worse off because the fair slots need not necessarily be at the top and there can be various pools of fair slots scattered throughout (as shown, for example, in FIG. 3) where in bidders might be given chance to obtain better slots but not necessarily the top ones depending on their bids and other parameters.

FIG. 3 illustrates an exemplary layouts 301-305 of a page returned after a search query by the CFFM schemes proposed in the present invention; A stands for “algorithmic results”, F is for “fair slots”, U is for “non-fair slots” (usual slots) and E stands for “exclusive slots”.

Further, although the risk from lower budget bidders seems to be shifting to the auctioneer, the auctioneer might not even lose significantly in terms of revenue and most importantly she is automatically able to obtain substantial information and can potentially test a new pool of bidders which might lead to an efficient monetization from the tail. Here below in the Section 1.1.1, we formally introduce this fair model which is collusion free in the sense that bidders do not trivially have incentives to collude. To illustrate this point, suppose all the slots are made fair and everyone is given an equal chance for obtaining each slot then since all bidders are essentially getting the same quality of service they can collectively agree upon a minimum possible bid value and the auctioneer might severely lose in revenue. The model proposed in the present invention avoids such a collusion possibility.

### 1.1.1 A Collusion Free Fair Model (CFFM)

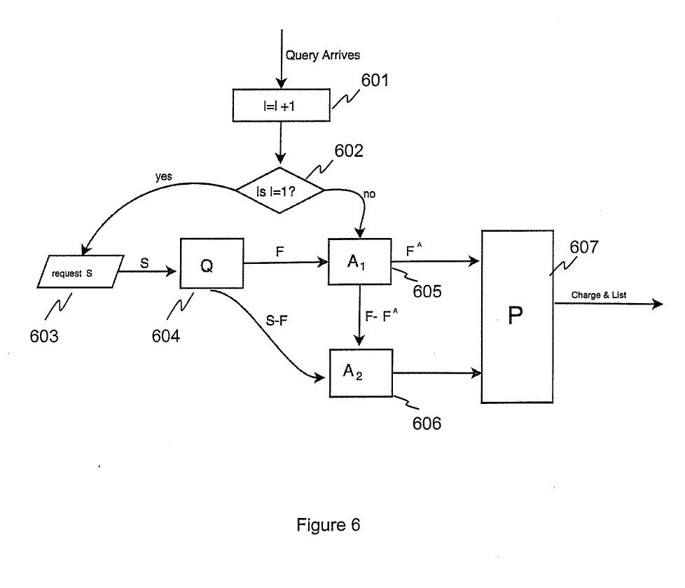

There are N bidders bidding for a specific item (such as a ‘keyword’ in sponsored search auctions) and this happens several times. There are K slots out of which some L slots (for example top ones) are chosen for fairness and are designated as fair slots. Bidder i has a true valuation tᵢ (known only to her) for this item and she has a budget bᵢ which is soft in the sense that she can stay up to the required number of steps if she participates for fair slots. Further let S be the set of bidders interested in the specific item. With this notation, the new auction framework has the following features, as illustrated in FIG. 6.

Steps 601 and 602 determine whether the received user query is the first query of the specific keyword or not. The algorithm starts with I=0.

At step 603, the bidders report their bids v₁, v₂, . . . v_{N}.

At step 604, the system determines the set F of bidders who “qualify” for the fair slots using a rule Q.

At step 605, the system uses a scheme A₁ to implement fairness that is to allocate fair slots, so that all bidders from F have equal chance of getting to the fair slots. A bidder who obtains a fair slot in this particular step is called fair-active at this step. Let us denote the set of fair-active bidders at this step as F^{A}.

Bidders from F who are not fair active at a particular step compete for non-fair slots among themselves and with bidders which are not in F. At step 606, the system uses an allocation scheme A₂ to assign the non-fair slots among bidders from S−F and F−F^{A} (i.e. S−F^{A}). This can ensure that bidders in F do not trivially collude because they are still competing and hence not getting the same quality of service.

At step 607, the system uses a pricing scheme P to charge the bidders who were assigned slots—fair or non-fair.

The bidders are given the respective slots-fair or non-fair as allocated above. For example, in the case of keyword auctions, the ads of the bidders are listed in the sponsored part of the results in the respective slots assigned to them.

To the most generality of the above framework, the qualifying scheme Q, the allocation rules A₁ and A₂ and the pricing scheme P can be any suitable schemes. For example, the qualifying rule Q can be “rank by relevance”, “rank by bid (RBB)” or “rank by revenue (RBR)” and choosing the top n bidders. The allocation rule A₁ can be a cyclic shifting of the ranking obtained from the Q applied for n steps where n is the number of bidders qualified according to Q. At a particular cyclic shifting step, the bidders who get their rank to be the ones designated as fair are given the respective fair slots. The allocation rule A₂ can be “rank by bid (RBB)” or “rank by revenue (RBR)”. The pricing rule P can be GFP or GSP or VCG payments in association with A₁ and A₂. Also the position of fair slots can be chosen to meet auctioneer's needs. For example, all the fair slots can be kept at the top or the fair slots can be scattered throughout in bands of slots, each band associated to a distinct CFFM by itself. In another embodiment, some slots and bidders can be designated as “exclusive” meaning they do not participate for fairness even if they qualify according to Q. Thus, the preferred embodiment presented in the following is solely for illustration purpose and any other suitable schemes when used in the present framework of fairness also falls in the scope of the present invention. In this preferred embodiment, the schemes Q, and A₂ are taken to be the same ranking rule (such as RBB, RBR) and the pricing scheme P is taken to be GSP. The allocation rule A₁ is a cyclic shifting of some ordering determined by Q. Therefore, the steps translates as the following:

(i) Bidders report their bids v₁, v₂, . . . , v_{N}.

(ii) System determines the set F of n bidders who “qualify” for the fair slots by using a ranking rule A (such as RBB or RBR) and choosing the top n bidders. Here L<K<N.

(ii) System uses the ranking rule A to order the qualified bidders and in fact it is the same ordering. Let us name the bidders according to this ranking, i.e. bidder m is the one ranked m according to A. This is the initial ordering i.e. the ordering at step 1.

(iii) This order is cyclically shifted for n−1 more steps to complete a round of n steps. Thus the initial ordering [1 2 . . . L|L+1 . . . n] changes to [2 3 . . . L L+1|L+2 . . . n 1] in step 2, [3 . . . L+2| . . . n 1 2] in step 3 and so on. A bidder will be called fair-active if this cyclically rotating rule assigns her one of the L slots designated fair.

(iv) The rotating round of n steps ensures that each one of the n bidders gets to each fair slot exactly once, thus they are fair-active for exactly L steps out of this n steps.

(v) Non-fair slots are allocated using A among the bidders from F who are not fair-active at the particular step along with the bidders which are not in F.

(v) Auctioneer uses GSP or a suitably modified version of it to charge the bidders who were assigned slots—fair or non-fair.

(vi) The bidders are given the respective slots-fair or non-fair as allocated above. For example, in the case of keyword auctions, the ads of the bidders are listed in the sponsored part of the results in the respective slots assigned to them.

### 1.1.2 Estimating the Relevance of New Bidders

One of important concerns for the auctioneer is that what relevance or the quality score should she/he assign to a bidder who is just joining the game. For example, in the case of adword auctions, what relevance/quality score should the search engine assign to a new advertiser. CFFM can automatically provide such an estimation. In a preferred embodiment, the system can initially assign a relevance score to the new bidder big enough so that she qualifies for the fair slots. Now suppose this new bidder was ranked m and let the number of times her ad was clicked during the n steps is M. If her true relevance is e then she is expected to get θₘ e clicks, therefore e can be estimated as M/θₘ. Here θₘ is the effective CTR of m as obtained in CFFM. Of course, we would like to note that there can be several other ways for estimating the relevance of new bidders even in the standard model without fairness. In one preferred embodiment illustrated in Section 1.4, the present invention provides such a method.

### 1.2 User Incentives and Long-Term Revenue

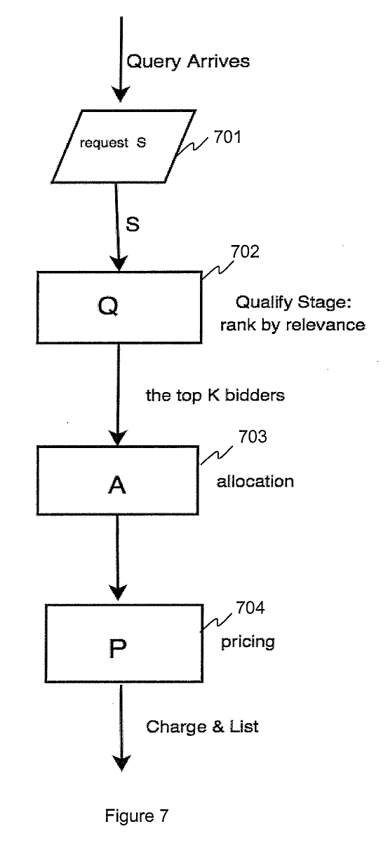

As we mentioned earlier, another very important element missing in the current adword framework is that it does not account for and optimize from the possibility that the click through rates (position based or overall) can change with the type of model/mechanism used. Thus it might be possible that some mechanism is more profitable in terms of revenue in short run than another while the other might have an effect of increasing CTRs for example by effecting the incentives of users and therefore the later mechanism might turn out to be more profitable in the long run. Further, CTR increase can have manifold of effects. It gives more attention to the bidders than before so they might have relatively more profits and their valuation might increase and they might like to bid even more in hope of getting better unit of the item and overall bid profile might actually improve. There are various ways in which CTRs and long-term revenues can be improved. For example, suppose the relevance of the bidder is given more weight than the bid value in determining the slot allocations then users are likely to prefer the units relatively better than before as they get more relevant information or service. Similarly, in the case of adword auction, suppose the quality of the ad and that of the advertiser i.e. the relevance is given more weight than the bid value in determining the slot allocations then users (i.e. the searchers) are more likely to click for they get more relevant information and therefore the click through rates can actually increase and in fact a new pool of searchers might get motivated to use this particular search engines due to high quality of information it provides even as ads. In the following, an embodiment of the present invention is described wherein such methods are provided. Deviating from the usual model, the system implements two distinguished stages—qualify and compete. In the “qualify” stage, the bidders are ranked according to their relevance and top K bidders are chosen to participate in the actual auction. Here relevance has a very broad meaning, for example in the case of adword auctions, it encompasses any of the parameters which are function of the advertiser and their ads that can potentially increase the possibility that searchers will click on the ad thereby increasing the CTRs. In the “compete” stage, these K qualified bidders compete among themselves. At this stage, the auctioneer can use a suitable allocation rule such as RBB or RBR and a suitable payment rule such as GFP or GSP. The qualify stage can ensure that only the highly relevant bidders are given the slots. For example in the case of adword auctions, the qualify stage can ensure that only the highly relevant ads are given the slots and therefore as argued earlier searchers are more likely to click than before and CTRs effectively increase, and searchers' pool might increase as well. In general this method has the following steps, which are illustrated in FIG. 7:

At step 701, bidders report their bids v₁, v₂, . . . , v_{N}.

“Qualify” Stage: system ranks the bidders by their “relevance” and choose the top K bidders at step 702.

At step 703, the system uses an allocation rule A to assign the K slots to the K bidders chosen in “qualify” stage.

At step 704, the system uses a pricing scheme P to charge the bidders who were assigned slots.

The bidders are given the respective slots as allocated above. For example, in the case of keyword auctions, the ads of the bidders are listed in the sponsored part of the results in the respective slots assigned to them.

In general, the above method can employ any suitable allocation rule A such as RBB, RBR and pricing scheme P such as GFP, GSP or VCG in association with A.

As was stated earlier, users' satisfaction is very important in the long-term revenue considerations and we illustrated one preferred embodiment of the present invention above where the relevance of the bidders is the key factor. Another interesting way the CTRs can be improved is via paying back to the users either directly in terms of money or in terms of some social points. In another embodiment of the present invention, the auctioneer/system pays some fraction of the amount that it gets from a bidder to the user who led to this payment (for example, by clicking on the ad under “Pay Per Click” in adword auction). Alternatively auctioneer/system can also provide that fraction of amount to the user in terms of equivalent social points. Note that with this user payback scheme, in particular for links that appear both in the organic results as well as ads, the users are more likely to click on the ads rather than on the organic results thus increasing the corresponding CTRs enormously.

Yet another trick to bring users in the bargaining process could be to let users be involved in estimating the quality scores and the ranks of the bidders i.e. by directly or indirectly involving them in the actual allocation of the slots among the bidders and pay them for their participation in such an estimation and ranking process. This could be achieved by taking surveys from the users and paying them back for this.

### 1.3 Bidder's Expressiveness: Improving the Bidding Language

This section is devoted to yet another dimension in which the current framework can be enriched and this lies in the question of how much information should we elicit from the bidders and how much preference about slot allocations they should be allowed to express while bidding. In other words, how rich the bidding language can be made without making it too much complicated. Let us illustrate it by examples. The currently used methods do not account for and do not optimize from the possibility that the quality of a particular unit of the item given to a particular bidder might also be effected by the identity of the bidders who got the other units. For example, in the case of adword auctions, CTR of an ad can depend on what are the other ads put in the nearby slots. Suppose for example, instead of first 3 slots, there is only a single ad with enlarged text then people are more likely to click on this compared to the case when there were two other ads accompanying this. Motivated by this, in one embodiment described in Section 1.3.1, the present invention proposes the notion of express slots and provides methods that account for bidders' expressiveness at allocation level. Further, the advertisers in general have different motivations behind advertising and accordingly they might be interested in paying in terms of PPM, PPC or PPA as suited to their needs. For instance, branding advertisers are mostly interested in impressions, direct marketers are mostly interested in conversions while some other advertisers might be interested just in increasing the lead traffic and accordingly the PPM, PPA and PPC suits to them respectively. This observation motivates another preferred embodiment of the present invention that provides methods where bidders are allowed to report their bid values as a vector and specify whether they are interested in impressions, leads or conversions. In general, for a specific keyword (or campaign) an advertiser can report a vector (v^{M}, v^{C}, v^{A}) indicating that she wants to pay an amount of v^{M} for impressions, v^{C} more if she gets a click, plus v^{A} if she actually gets a conversion. This particular embodiment is summarized in Section 1.3.2.

### 1.3.1 Express Slots: Allocation Level Preferences

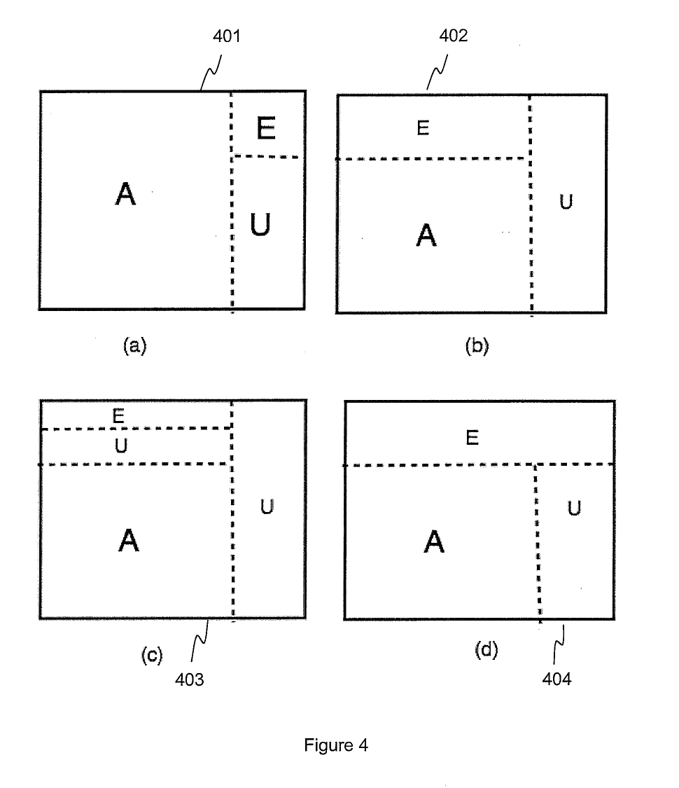

In this embodiment of the present invention, some slots are designated as express slots, as shown, for example, in FIG. 4. FIG. 4 illustrates an exemplary layouts 401-404 of a page returned after a search query by the schemes for incorporating allocation level expressiveness of bidders as proposed in the present invention. A stands for “algorithmic results”, E is for “express slots” and U is for “non-express slots” (usual slots).

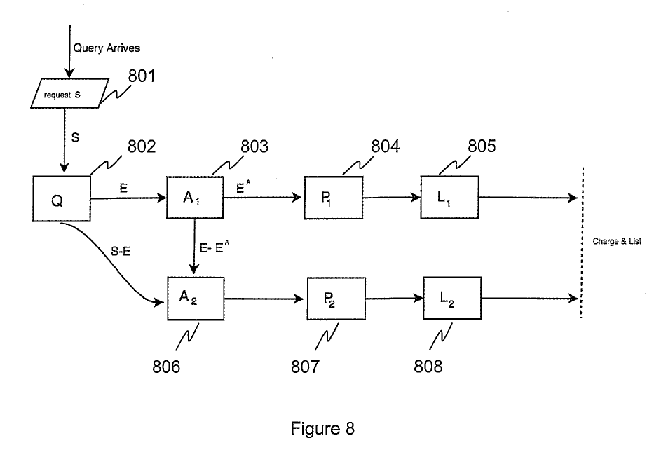

Generally, bidders would prefer to be in express slots. Further, any one who is assigned to one of these express slots is allowed to express some further preferences, for example she can express her preferences that she does not want some other bidders to be in the express slots and is willing to pay an extra amount if granted such preferences. Therefore, apart from their bid values vᵢ's and budget bᵢ's, the bidders also report two new parameters, the set lᵢ of bidders that i does not want to appear in express slots and vᵢ^{e}, the extra amount that i is willing to pay the most to achieve her preferences or a subset of them. The method has the following steps, which are illustrated in FIG. 8 for the specific case of adword auctions:

At step 801, bidders reports their values i.e. the vector (vᵢ, vᵢ^{e}, lᵢ, bᵢ).

Using a qualifying rule Q, at step 802, the system decides the set E of bidders who qualify for the express slots.

Using an allocation rule A₁, at step 803, the system assigns the express slots to the set E^{A}⊂E of bidders.

At step 804, the system uses P₁ to decide payments from the bidders who are assigned express slots. The unassigned express slots might be distributed among the bidders who got other express slots. For example, in the case of adword auctions, system can use a formatting style L₁ (step 805) to list them in the express slots.

Using an allocation rule A₂, at step 806, the system assigns all the other slots (non-express slots) to the bidders from S−E and E−E^{A}.

At step 807, the system uses P₂ to decide payments from the bidders who are assigned non-express slots. System might use a different formatting style L₂ to list them in the express slots in the case of adword auctions (step 808).

In general, the above method can employ any suitable qualifying rule Q (such as rank by relevance), allocation rules A₁ and A₂ (such as RBB, RBR), pricing rules P₁ and P₂ (such as GFP, GSP) and formatting styles L₁ and L₂. Let us illustrate this method by a preferred embodiment as follows:

(i) Bidders reports their values i.e. the vectors (vᵢ, vᵢ^{e}, lᵢ, bᵢ).

(ii) Qualify (Q): The system ranks the bidders by their “relevance” and choose top K^{e} bidders to participate for the express slots. Here K^{e} is the total number of express slots. Thus E is the set of top K^{e} bidders according to this ranking.

(iii) Express allocation (A₁), express pricing (P₁) and express formatting (L₁): The system ranks the bidders from E using RBR. Using GSP, it decides the payments that the bidders are supposed to pay but the actual amount they will be required to pay is decided as follows. System looks at which bidders are to be kicked out and only a highly ranked bidder can force the lowly ranked bidder out. It looks at j^{th} bidder's preference set lⱼ and kick out as many bidders as possible in the decreasing order of ranks up to the bidder so that payment from all these bidders being forced out due to j, as decided by the above GSP is still not beyond vⱼ^{e}. All the bidders who are not forced out of the express slots consists the set E^{A} and are assigned the respective slots according to the above RBR. A bidder i in E^{A} is charged an amount equal to what she was supposed to pay plus the amount of bidders in lᵢ who were forced out of express slots. Their texts and links are now formatted nicely by enlarging and using impressive fonts.

(iv) Non-express allocation (A₂), non-express pricing (P₂) and non-express formatting (L₂): The system ranks the bidders from S−E and E−E^{A} together using RBR and assigns them the K-K^{e} non-express slots accordingly. The bidders are charged using GSP and the formatting style is the one being used currently.

### 1.3.2 Multi-Dimensional Bidding Language: Payment Level Preferences

In this section, we summarize yet another embodiment of the present invention which provides a method that incorporates expressiveness and improves the bidding language at the payment level. The structure basically remains the same as in the current models or the models discussed in the other embodiments of the present invention but in addition bidders are now allowed to specify the kind of types they want to make payment in terms of—whether they want to pay as per impression or per click or per conversion or in general how much amount they want to pay for impression, click and conversion respectively. So now their bid values becomes vectors (vᵢ^{M}, vᵢ^{C}, vᵢ^{A}) where vᵢ^{M} is the amount i wants to pay per impression, vᵢ^{C} is the extra amount she is willing to pay if she gets a click and vᵢ^{A} is further extra amount she is willing to pay if she gets a conversion. The method has similar steps as discussed in earlier sections. System uses some qualifying rule Q to choose bidders who will actually participate, then uses an allocation rule A and pricing rule P to assign them slots and then charge them for the same. For illustration we can consider the following preferred embodiment:

(i) Bidders report their values (vᵢ^{M}, vᵢ^{C}, vᵢ^{A}) and system computes vᵢ:=vᵢ^{M}+vᵢ^{C}+vᵢ^{A}.

(ii) System allows everyone to participate and uses RBR to rank the bidders using vᵢ's as the bid values and allocates the slots according to this ranking. Let us rename the bidders according to this ranking. Thus we have e₁v₁>e₂v₂> . . . >eₙvₙ and the top K bidders are assigned the respective slots.

(iii) System uses a modified GSP scheme to charge the bidders who were assigned a slot as follows: the bidder being assigned slot j is charged pⱼ^{M} per impression, pⱼ^{C} more per click plus pⱼ^{A} more per conversion where

$${p}_{j}^{M} = \frac{{υ}_{i}^{M}}{{υ}_{i}} \frac{{υ}_{i + 1} {e}_{i + 1}}{{e}_{i}} ; {p}_{j}^{C} = \frac{{υ}_{i}^{C}}{{υ}_{i}} \frac{{υ}_{i + 1} {e}_{i + 1}}{{e}_{i}} ; {p}_{j}^{A} = \frac{{υ}_{i}^{A}}{{υ}_{i}} \frac{{υ}_{i + 1} {e}_{i + 1}}{{e}_{i}} .$$

### 1.4 Another Method for Estimating the Relevance of New Advertisers

As we mentioned in Section 1.1.2, there can be several other ways for estimating the relevance of new bidders even in the standard model without fairness. Here below we illustrate such a method provided by one preferred embodiment of the present invention.

Let eᵢ and vᵢ are the relevance and the bid value of bidder i. The mechanism used for allocating slots is RBR and the payments are charged according to GSP. Therefore, bidders are ranked according to eᵢvᵢ. Wlog let us assume for simplicity of notation that bidder i is the one who got ranked i according to RBR, then under GSP, is charged (eᵢ₊₁ vᵢ₊₁)/eᵢ. Further, there are K slots and first assume that there are enough bidders to fill K slots up and if any new advertiser is given a slot then the K^{th} advertiser goes out. (The method easily generalizes to the case when there are not enough bidders)

The original revenue without introducing the new bidder is

$${R}_{0} = {\sum }_{j = 1}^{K} {γ}_{j} {e}_{j + 1} {υ}_{j + 1} .$$

Now suppose we want to estimate the relevance e of a new bidder whose bids v, then what relevance should the system give her to start with and equivalently what slot should be assigned to her so that auctioneer does not loose in revenue on average. Let us consider assigning her a slot i by giving her an initial relevance e_{I}ⁱ just enough to ensure this slot i.e. by assigning her e_{I}ⁱ=(eᵢvᵢ)/v. In this case the new revenue of the auctioneer is

$${R}_{i} = {\sum }_{j = 1}^{i - 2} {γ}_{j} {e}_{j + 1} {υ}_{j + 1} + {γ}_{i - 1} {e}_{I}^{i} υ + {γ}_{i } e \frac{{e}_{i} {υ}_{i}}{{e}_{I}^{i}} + {\sum }_{j = i + 1}^{K} {γ}_{j} {e}_{j} {υ}_{j}$$

for i≧2 and

$${R}_{1} = {γ}_{1} e \frac{{e}_{1} {υ}_{1}}{{e}_{I}^{1}} + {\sum }_{j = 2}^{K} {γ}_{j} {e}_{j} {υ}_{j} .$$

Therefore, the change in revenue is

$$Δ {R}_{i} := {R}_{i} - {R}_{0} = {γ}_{i - 1} ( {e}_{I}^{i} υ - {e}_{i} {υ}_{i} ) + {γ}_{i} ( e \frac{{e}_{i} {υ}_{i}}{{e}_{I}^{i}} - {e}_{i + 1} {υ}_{i + 1} ) + {\sum }_{j = i + 1}^{K} {γ}_{j} ( {e}_{j} {υ}_{j} - {e}_{j + 1} {υ}_{j + 1} ) \geq {γ}_{i} ( e υ - {e}_{i + 1} {υ}_{i + 1} ) \\ ∴ Δ {\overline{R}}_{i} \geq ( \overline{e} υ - {e}_{i + 1} {υ}_{i + 1} )$$

for i≧2 and similarly

Thus there will be no loss in expected revenue if we assign the new bidder the slot i only if

$$υ \geq \frac{{e}_{i + 1} {υ}_{i + 1}}{\overline{e}}$$

Here ē is the expected value of the relevance of a new bidder which follows some distribution g known to auctioneer (system), i.e. ē=E_{g}[e]

Let

$${i}_{0} = {min}_{i} \{ i : υ \geq \frac{{e}_{i + 1} {υ}_{i + 1}}{\overline{e}} \} ,$$

then any slot lower than (i.e. more in index) or equal to i₀ can be assigned without any loss in expected revenue, and thus we can even have a randomized assignment as long as its support is on these indices.

Now the system follows the above procedure to assign slots to the new bidder for M queries of the specific keyword and say the her ad was clicked L times out of these M queries and let i₁, i₂, . . . i_{M} be the slots that were assigned to her, then the expected number of clicks that she should receive is

$${\sum }_{j = 1}^{M} {γ}_{{i}_{j}} e .$$

System estimates

$$e = \frac{L}{{\sum }_{j = 1}^{M} {γ}_{{i}_{j}}}$$

which is true with high probability.

### 1.5 An Exemplary Embodiment

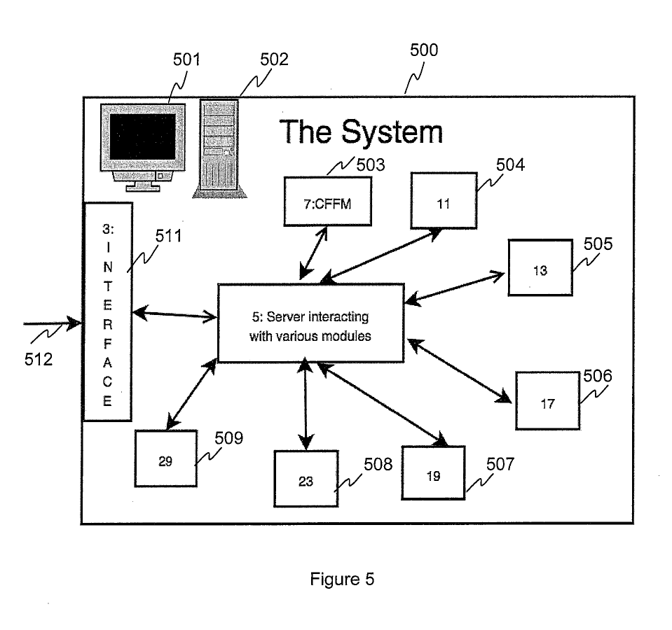

FIG. 5 illustrates an exemplary embodiment of an inventive system 500, which can be deployed on a server 502 having a display unit 501. In the shown system modules 503, 504, etc. are various modules implementing various methods provided by various embodiments of the present invention, 512 represents the information being submitted by the bidders to the system through the interface 511; 503 is the module implementing the inventive method for fairness and 504 is the module for estimating various parameters such as relevance using the CFFM; 505, 506 implement the methods effecting user incentives by ranking by relevance and by user payback respectively; 507, 508 are modules for allocation level and payment level bidders' expressiveness respectively and 509 is the module implementing the method described in Section 1.4 to estimate relevance.

### 1.6 Exemplary Computer Platform

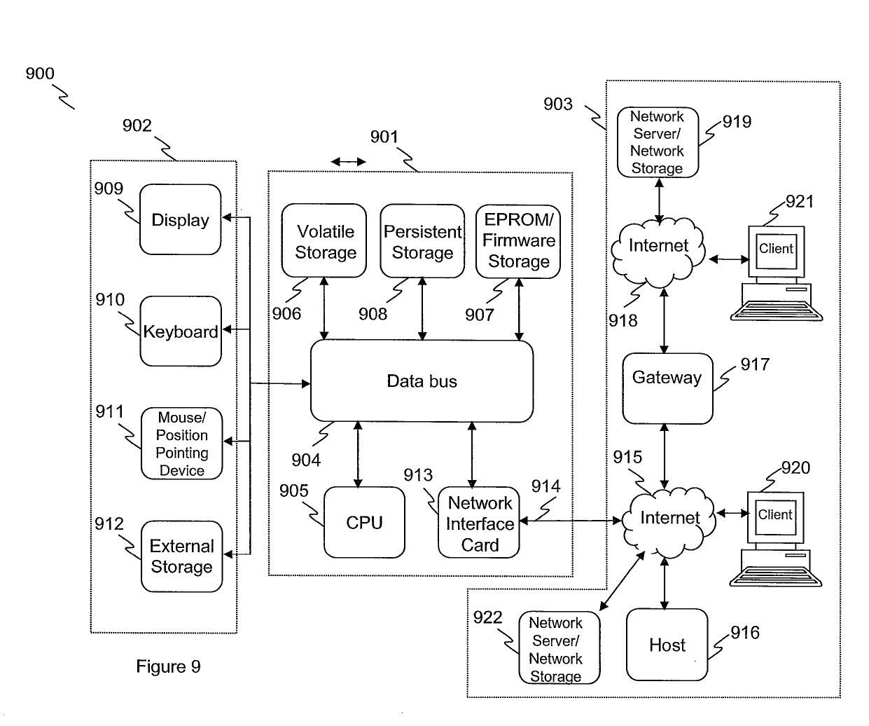

FIG. 9 is a block diagram that illustrates an embodiment of a computer/server system 900 upon which an embodiment of the inventive methodology may be implemented. The system 900 includes a computer/server platform 901, peripheral devices 902 and network resources 903.

The computer platform 901 may include a data bus 904 or other communication mechanism for communicating information across and among various parts of the computer platform 901, and a processor 905 coupled with bus 901 for processing information and performing other computational and control tasks. Computer platform 901 also includes a volatile storage 906, such as a random access memory (RAM) or other dynamic storage device, coupled to bus 904 for storing various information as well as instructions to be executed by processor 905. The volatile storage 906 also may be used for storing temporary variables or other intermediate information during execution of instructions by processor 905. Computer platform 901 may further include a read only memory (ROM or EPROM) 907 or other static storage device coupled to bus 904 for storing static information and instructions for processor 905, such as basic input-output system (BIOS), as well as various system configuration parameters. A persistent storage device 908, such as a magnetic disk, optical disk, or solid-state flash memory device is provided and coupled to bus 901 for storing information and instructions.

Computer platform 901 may be coupled via bus 904 to a display 909, such as a cathode ray tube (CRT), plasma display, or a liquid crystal display (LCD), for displaying information to a system administrator or user of the computer platform 901. An input device 910, including alphanumeric and other keys, is coupled to bus 901 for communicating information and command selections to processor 905. Another type of user input device is cursor control device 911, such as a mouse, a trackball, or cursor direction keys for communicating direction information and command selections to processor 904 and for controlling cursor movement on display 909. This input device typically has two degrees of freedom in two axes, a first axis (e.g., x) and a second axis (e.g., y), that allows the device to specify positions in a plane.

An external storage device 912 may be connected to the computer platform 901 via bus 904 to provide an extra or removable storage capacity for the computer platform 901. In an embodiment of the computer system 900, the external removable storage device 912 may be used to facilitate exchange of data with other computer systems.

The invention is related to the use of computer system 900 for implementing the techniques described herein. In an embodiment, the inventive system may reside on a machine such as computer platform 901. According to one embodiment of the invention, the techniques described herein are performed by computer system 900 in response to processor 905 executing one or more sequences of one or more instructions contained in the volatile memory 906. Such instructions may be read into volatile memory 906 from another computer-readable medium, such as persistent storage device 908. Execution of the sequences of instructions contained in the volatile memory 906 causes processor 905 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 905 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 908. Volatile media includes dynamic memory, such as volatile storage 906. Transmission media includes coaxial cables, copper wire and fiber optics, including the wires that comprise data bus 904. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 905 for execution. For example, the instructions may initially be carried on a magnetic disk from a remote computer. Alternatively, a remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on the data bus 904. The bus 904 carries the data to the volatile storage 906, from which processor 905 retrieves and executes the instructions. The instructions received by the volatile memory 906 may optionally be stored on persistent storage device 908 either before or after execution by processor 905. The instructions may also be downloaded into the computer platform 901 via Internet using a variety of network data communication protocols well known in the art.

The computer platform 901 also includes a communication interface, such as network interface card 913 coupled to the data bus 904. Communication interface 913 provides a two-way data communication coupling to a network link 914 that is connected to a local network 915. For example, communication interface 913 may be an integrated services digital network (ISDN) card or a modem to provide a data communication connection to a corresponding type of telephone line. As another example, communication interface 913 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 913 sends and receives electrical, electromagnetic or optical signals that carry digital data streams representing various types of information.

Network link 913 typically provides data communication through one or more networks to other network resources. For example, network link 914 may provide a connection through local network 915 to a host computer 916, or a network storage/server 917. Additionally or alternatively, the network link 913 may connect through gateway/firewall 917 to the wide-area or global network 918, such as an Internet. Thus, the computer platform 901 can access network resources located anywhere on the Internet 918, such as a remote network storage/server 919. On the other hand, the computer platform 901 may also be accessed by clients located anywhere on the local area network 915 and/or the Internet 918. The network clients 920 and 921 may themselves be implemented based on the computer platform similar to the platform 901.

Local network 915 and the Internet 918 both use electrical, electromagnetic or optical signals that carry digital data streams. The signals through the various networks and the signals on network link 914 and through communication interface 913, which carry the digital data to and from computer platform 901, are exemplary forms of carrier waves transporting the information.

Computer platform 901 can send messages and receive data, including program code, through the variety of network(s) including Internet 918 and LAN 915, network link 914 and communication interface 913. In the Internet example, when the system 901 acts as a network server, it might transmit a requested code or data for an application program running on client(s) 920 and/or 921 through Internet 918, gateway/firewall 917, local area network 915 and communication interface 913. Similarly, it may receive code from other network resources.

The received code may be executed by processor 905 as it is received, and/or stored in persistent or volatile storage devices 908 and 906, respectively, or other non-volatile storage for later execution. In this manner, computer system 901 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized system for auctioning of distinguishable units of an item. It is intended that the specification and examples be considered as exemplary only, with a true scope and spirit of the invention being indicated by the following claims.

What is claimed is:

1. A method for auctioning an item having a plurality of distinct units to a plurality of bidders, each of the plurality of distinct units having at least one different quality, the method comprising:
a. Designating at least one of the plurality of distinct units as fair slots; and
b. Determining a subset of the plurality of bidders who qualify for the fair slots (qualified bidders) using a qualifying rule.

2. The method of claim 1, further comprising ranking the bidders based on at least one ranking criterion, wherein the qualified bidders comprise at least one low-ranked bidder.

3. The method of claim 1, wherein the item is a specific keyword in an internet search system, wherein the distinct units of the item correspond to different advertisement slots for the keyword, and wherein the quality is a click-through rate corresponding to the advertising slot.

4. The method of claim 1, further comprising:
a. Receiving a plurality of bids for the item from the plurality of bidders;
b. Allocating the fair slots to the qualified bidders using a first allocation scheme;
c. Assigning non-fair slots to at least one of qualified bidders not assigned to a fair slot according to the first allocation scheme or at least one of non-qualified bidders, using a second allocation scheme;
d. Using a pricing scheme to charge bidders of the plurality of bidders who were assigned at least one of the fair slots or at least one of the non-fair slots;
e. Providing the allocated fair slots or non-fair slots to the plurality of bidders.

5. The method of claim 4, wherein the first allocation scheme provides all qualified bidders an equal chance to obtain the fair slots.

6. The method of claim 4, wherein the first and the second allocation schemes ensure that the plurality of bidders do not collude.

7. The method of claim 4, wherein the qualifying rule comprises ranking the plurality of bidders by a relevance, by a bid amount (RBB), or by a revenue (RBR) and choosing the top n ranked bidders and wherein the revenue is computed by obtaining a product of the bid amount and the relevance.

8. The method of claim 7, wherein the first allocation scheme comprises a cyclic shifting of the ranking obtained from the qualifying rule, applied for a predetermined number of cyclic shifting steps equal to a number of the qualified bidders and wherein at each cyclic shifting step, the bidders who get their ranks to be the ones designated as fair are given the respective fair slots.

9. The method of claim 4, wherein the second allocation scheme comprises ranking the plurality of bidders by a bid amount (RBB) or by a revenue (RBR) and wherein the revenue is computed by obtaining a product of the bid amount and a relevance.

10. The method of claim 4, wherein the pricing scheme comprises Generalized First Price (GFP), Generalized Second Price (GSP), or VCG payments.

11. The method of claim 4, wherein the fair slots are kept at a top of the plurality of slots.

12. The method of claim 4, wherein the fair slots are scattered throughout in bands of slots, each band being treated independently with respect to the qualifying rule, the first and second allocation schemes and the pricing scheme.

13. The method of claim 4, wherein at least one slot and at least one of the plurality of bidders are designated as exclusive and wherein the exclusive slots are not allowed to be designated as the fair slots and the exclusive bidders are not allowed to be allocated to the fair slots.

14. The method of claim 4, further comprising estimating relevance of a new bidder, the method comprising: assigning an initial relevance score to the new bidder, the initial relevance being assigned such that the new bidder is a qualified bidder and estimating a true relevance proportionally to a number of activations of an advertisement of the bidder.

15. The method of claim 4, further comprising estimating conversion rates of at least some of the plurality of bidders proportionally to a number of predefined transactions after an activation of an advertisement of the bidder.

16. A method for optimizing long term revenue in a system for auctioning of a plurality of slots to a plurality of bidders by effecting user incentives, the method comprising:
a. Receiving a plurality of bids for the plurality of slots from the plurality of bidders;
b. Ranking the plurality of bidders by relevance and choosing a plurality of top bidders;
c. Assigning at least some of the plurality of slots to the plurality of top bidders using an allocation rule;
d. Charging the plurality of top bidders who have been assigned at least some of the plurality of slots using a pricing scheme;
e. Providing the assigned slots to the plurality of top bidders.

17. The method of claim 16, wherein the plurality of slots are advertising slots associated with a search keyword.

18. The method of claim 17, wherein the relevance of a first bidder is determined based on at least one parameter of the first bidder.

19. The method of claim 17, wherein the at least one parameter of the first bidder comprises advertising quality of the first bidder that can potentially increase possibility that users will click on an advertising corresponding to a slot of the first bidder.

20. The method of claim 16, wherein the allocation rule comprises ranking by bid (RBB) or ranking by revenue (RBR).

21. The method of claim 16, wherein the pricing scheme comprises GFP, GSP or VCG payments in association with the ranking.

22. The method of claim 16, further comprising paying a user associated with a slot of a first bidder at least a fraction of the amount of a bid of the first bidder.

23. A method for optimizing long term revenue in a system for auctioning of a plurality of slots to a plurality of bidders by improving a bidding language, the method comprising designating at least one slot of the plurality of slots as express slots, wherein bidders are allowed to express allocation level preferences with respect to the express slots, the allocation level preferences comprising a list of excluded bidders for each bidder that the bidder does not desire to appear in the express slots.

24. The method of claim 23, wherein the plurality of slots are advertising slots associated with a search keyword.

25. A method of claim 23, further comprising:
a. Receiving a value vector from each bidder, the value vector comprising a bid, information on the excluded bidders and an amount that the bidder is willing to pay for exclusion of the excluded bidders;
b. Using a qualifying rule to decide bidders who qualify for the express slots;
c. Using a first allocation rule to assign the express slots to a subset of the qualified bidders;
d. Using a first pricing scheme to determine payments from the qualified bidders assigned to the express slots.
e. Using a second allocation rule to assign non-express slots to the other bidders;
f. Using a second pricing scheme to determine payments from the bidders who are assigned non-express slots.

26. The method of claim 25, wherein the qualifying rule comprises ranking the plurality of bidders by relevance.

27. The method of claim 25, wherein the first allocation rule comprises ranking by the bid (RBB) or ranking by a revenue (RBR).

28. The method of claim 25, wherein the second allocation rule comprises ranking by the bid (RBB) or ranking by a revenue (RBR).

29. The method of claim 25, wherein the first pricing scheme comprises charging a bidder GFP or GSP payments that the bidder is supposed to pay in absence of expression level preferences plus an amount the bidder reported to pay for exclusion of the excluded bidders.

30. The method of claim 25, wherein the second pricing scheme comprises GFP or GSP.

31. A method for enabling payment level preferences of bidders in an auction of plurality of slots to a plurality of bidders, the method comprising:
a. Receiving from each bidder bid information, the bid information comprising an amount the bidder wants to pay per impression, the extra amount the bidder wants to pay if the bidder gets a click and an extra amount the bidder is willing to pay if the bidder gets a conversion;
b. Using a qualifying rule to identify bidders who will actually participate;
c. Using an allocation rule to assign the plurality of slots to the participating bidders; and
d. Using a pricing scheme to determine payments from the participating bidders.

32. A method for estimating a relevance score of a new bidder in auctioning of a plurality of advertisement slots to a plurality of bidders, the method comprising:
a. Receiving a plurality of bids for the plurality of advertisement slots from the plurality of bidders;
b. Ranking the bidders using a product of respective bids and respective relevances (RBR), wherein the new bidder is assigned an initial relevance such that the new bidder obtains an advertisement slot without causing any loss in an expected revenue of an auctioneer with respect to that coming from other bidders in absence of the new bidder; and
c. Estimating a true relevance of the new bidder proportionally to a number of activations of an advertisement of the bidder.
